(19) United States
(12) Patent Application Publication
(10) Pub. No.: US 2023/0093094 A1
(43) Pub. Date: Mar. 23, 2023

(54) HEAVY RARE EARTH ALLOY, NEODYMIUM-IRON-BORON PERMANENT MAGNET MATERIAL RAW MATERIAL, AND PREPARATION METHOD

(71) Applicant: FUJIAN CHANGTING GOLDEN DRAGON RARE-EARTH CO., LTD, Fujian (CN)

(72) Inventors: Zhipeng JIANG, Fujian (CN); Jiaying HUANG, Fujian (CN); Yao SHI, Fujian (CN); Ying LUO, Fujian (CN)

(21) Appl. No.: 17/785,501

(22) PCT Filed: May 21, 2021
(86) PCT No.: PCT/CN2021/095091

§ 371 Date: Jun. 15, 2022

(30) Foreign Application Priority Data
Jun. 11, 2020 (CN) 202010528355.3

(51) Int. Cl. H01F 1/055; C22C 28/00; C22C 38/16; C22C 38/14; C22C 38/12; C22C 38/10; C22C 38/06; C22C 38/00; B22F 3/16; C22C 33/02

(52) U.S. Cl. CPC H01F 1/0551; C22C 28/00; C22C 38/16; C22C 38/14; C22C 38/12; C22C 38/10; C22C 38/06; C22C 38/005; C22C 38/002; B22F 3/16; C22C 33/0278; B22F 2202/05; B22F 2201/20; B22F 2201/11; C22C 2202/02; B22F 2301/355

(57) ABSTRACT

Disclosed in the present invention are a heavy rare earth alloy, neodymium-iron-boron permanent magnet material, a raw material, and a preparation method. The heavy rare earth alloy comprises the following components: RH: 30-100 mas %, not including 100 mas %; X, 0-20 mas %, not including 0; B: 0-1.1 mas %; and Fe and/or Co: 15-69 mas %, RH comprising one or more heavy rare earth elements in Gd, Tb, Dy, Ho, Er, Tm, Yb, Lu, and Sc, and X being Ti and/or Zr. When the heavy rare earth alloy of the present invention is used as a sub-alloy to prepare the neodymium-iron-boron permanent magnet material, a high utilization rate of heavy rare earth is achieved, so that the coercivity can also be greatly improved while the neodymium-iron-boron permanent magnet material maintains high remanence.

### TECHNICAL FIELD

The present disclosure relates to heavy rare earth alloy, neodymium-iron-boron permanent magnet material, raw material, and preparation method.

### BACKGROUND

Due to the characteristics of high remanence, high coercivity and high magnetic energy product, neodymium-iron-boron rare earth permanent magnet materials are widely used in fields of power electronics, communication, information, motor, transportation, office automation, medical devices, military, etc., and makes it possible for the market application of some small and highly integrated high-tech products, such as voice coil motor (VCM) for hard disk, hybrid electric vehicle (HEV), electric vehicle, etc. To satisfy the above market demand, neodymium-iron-boron magnets with high remanence and high coercivity need to be prepared at a lower cost; in particular, as the permanent magnet motor in the field of new energy vehicles has higher working temperature, a magnet having higher coercivity is required.

At present, the methods for improving the coercivity of neodymium-iron-boron permanent magnets in the prior art mainly include some as follows:

(1) Single alloy preparation process: pure metals of Tb and Dy or alloys containing Tb and Dy are added directly in the process of alloy melting to improve the coercivity of neodymium-iron-boron magnets by using the high magnetocrystalline anisotropy field (HA) of Tb₂Fe₁₄B and Dy₂Fe₁₄B, however, due to the saturation magnetization (Ms) of Tb₂Fe₁₄B and Dy₂Fe₁₄B formed by Tb and Dy elements is much lower than that of Nd₂Fe₁₄B, the remanence of the magnet would be significantly reduced, and the addition amount of heavy rare earth elements Tb and Dy in this process is relatively large, thus the cost of raw materials is high.

(2) Grain boundary diffusion process: the surface of sintered neodymium-iron-boron magnet is covered with a layer of diffusion source material containing heavy rare earth elements Dy or Tb (including inorganic rare earth compounds, rare earth metals or rare earth alloys) by means of coating, sputtering, evaporation, etc., and then high-temperature diffusion is carried out at a temperature higher than the melting point of Nd rich phase at the grain boundary and lower than the sintering temperature of the magnet, so that Dy or Tb infiltrates into the interior along the grain boundary of the magnet, forming a (Nd, Dy)₂Fe₁₄B or (Nd, TB)₂Fe₁₄B magnetic hard layer with high anisotropic field on the surface of the main phase grain of Nd₂Fe₁₄B to improve the coercivity of the magnet. Since Dy and Tb are only present in the most epitaxial region of the main phase grain, this method can greatly reduce the amount of heavy rare earth Dy and TB used, at the same time, due to the limited diffusion depth in the grains, the method can effectively inhibit the reduction of magnet remanence. However, this method has high requirements for equipment, and requires large investment and complex operation, while large-sized magnets cannot be prepared thereby due to limited diffusion depth (the thickness of magnet is generally required to be no more than 1 cm).

(3) Double-alloy method is a method to increase coercivity by improving the microstructure of the magnet and the boundary structure of the magnetic phase, this method uses a heavy rare earth element-enriched alloy as the auxiliary phase, with the alloy composition of the main phase is close to the stoichiometric ratio of Nd₂Fe₁₄B, then the main and auxiliary phases are mixed to obtain a magnet by pressing, sintering and annealing. This method is not limited by the size of the permanent magnet, and can prepare a large-sized neodymium-iron-boron magnet with high coercivity. However, due to the high temperature in the sintering stage, the heavy rare earth elements added as an auxiliary phase will diffuse into the main phase in large quantities, resulting in a decrease in the remanence of the magnet; meanwhile, the increasing value of heavy rare earth elements diffused into the main phase in large quantities on coercivity is less than the effect of improving the grain boundary structure by their distribution on the grain surface, which will lead to low utilization of heavy rare earth elements and limited improvement of coercivity.

Therefore, there is an urgent need for a neodymium-iron-boron permanent magnet material with high utilization rate of heavy rare earth and great improvement of coercivity while maintaining a relatively high remanence.

### CONTENT OF THE PRESENT INVENTION

The technical problem to be solved in the present disclosure is to overcome the defect that the heavy rare earth elements in the auxiliary phase are diffused excessively to the main phase during the sintering process when using double alloy method for preparing the R-T-B permanent magnet material in the prior art, resulting in remanence reduction of the magnet, limited increase of coercivity and low utilization rate of heavy rare earth, and a heavy rare earth alloy, neodymium-iron-boron permanent magnet material, raw material, and preparation method are provided, which has a high utilization rate of heavy rare earth and great improvement of coercivity while retaining high remanence.

The present disclosure solves the above technical problems through the following technical solutions:

The first purpose of the present disclosure is to provide a heavy rare earth alloy comprising the following components by mass percentage: RH: 30-100 mas %, exclusive of 100 mas %; X, 0-20 mas %, exclusive of 0; B: 0-1.1 mas %; and Fe and/or Co: 15-69 mas %, wherein the sum of each component is 100 mas %, wherein mas % refers to the mass percentage relative to the heavy rare earth alloy;

RH comprising one or more heavy rare earth elements selected from the group consisting of Gd, Tb, Dy, Ho, Er, Tm, Yb, Lu and Sc;

and X being Ti and/or Zr.

In the present disclosure, the heavy rare earth alloy can also comprise other conventional elements in the art, when adding elements, the mass percentage content of existing elements of the heavy rare earth alloy does not change, except Fe and/or Co, and Fe and/or Co make up the balance by 100%; that is, for the dosage of each element, the mass percentage content of existing elements does not change, except Fe and/or Co, and the sum of each element is achieved to be 100% just by decreasing or increasing the percentage content of Fe and/or Co.

In the present disclosure, the content range of RH is preferably 30-90 mas %, more preferably 40-80 mas %, for example, 69 mas %, 60.2 mas %, 62.5 mas % or 75 mas %, wherein mas % refers to the mass percentage relative to the heavy rare earth alloy.

In the present disclosure, the type of RH preferably comprises one or more heavy rare earth elements selected from the group consisting of Tb, Dy, Ho and Gd, more preferably Tb and/or Dy.

In the present disclosure, when RH comprises Tb, the content range of Tb is preferably 30-75 mas %, for example, 50.2 mas %, 30 mas % or 34 mas %, wherein mas % refers to the mass percentage relative to the heavy rare earth alloy.

In the present disclosure, when RH comprises Dy, the content range of Dy is preferably 3-75 mas %, for example, 5 mas %, 50 mas % or 69 mas %, wherein mas % refers to the mass percentage relative to the heavy rare earth alloy.

In the present disclosure, when RH comprises Ho, the content range of Ho is preferably 2-50 mas %, for example, 2.3 mas % or 10 mas %, wherein mas % refers to the mass percentage relative to the heavy rare earth alloy.

In the present disclosure, when RH comprises Gd, the content range of Gd is preferably 2-50 mas %, for example, 5 mas % or 23.2 mas %, wherein mas % refers to the mass percentage relative to the heavy rare earth alloy.

In the present disclosure, when RH comprises Tb and Dy, the content range of “Tb and Dy” is preferably 30-90 mas %, for example, 35 mas % or 37 mas %, wherein mas % refers to the mass percentage relative to the heavy rare earth alloy.

In the present disclosure, when RH comprises Tb and Ho, the content range of “Tb and Ho” is preferably 30-90 mas %, for example, 60.2 mas % or 36.3 mas %, wherein mas % refers to the mass percentage relative to the heavy rare earth alloy.

In the present disclosure, when RH comprises Tb and Gd, the content range of “Tb and Gd” is preferably 30-90 mas %, for example, 35 mas % or 57.2 mas %, wherein mas % refers to the mass percentage relative to the heavy rare earth alloy.

In the present disclosure, when RH comprises Tb, Dy and Gd, the content range of “Tb, Dy and Gd” is preferably 30-90 mas %, for example, 40 mas % or 57.2 mas %, wherein mas % refers to the mass percentage relative to the heavy rare earth alloy.

In the present disclosure, when RH comprises Tb, Dy, Ho and Gd, the content range of “Tb, Dy, Ho and Gd” is preferably 30-90 mas %, for example, 62.5 mas %, wherein mas % refers to the mass percentage relative to the heavy rare earth alloy.

In the present disclosure, the content range of X is preferably 3-15 mas %, for example, 7.27 mas %, 7.5 mas %, 8 mas % or 8.25 mas %; more preferably 3-10 mas %, wherein mas % refers to the mass percentage relative to the heavy rare earth alloy.

In the present disclosure, when X comprises Zr, the content range of Zr is preferably 3-10%, for example, 7.27 mas %, 4 mas % or 2 mas %, wherein mas % refers to the mass percentage relative to the heavy rare earth alloy.

In the present disclosure, when X comprises Ti, the content range of Ti is preferably 3-15%, for example, 7.5 mas %, 4 mas % or 6.25 mas %, more preferably 3-10%, wherein mas % refers to the mass percentage relative to the heavy rare earth alloy.

In the present disclosure, when X comprises a mixture of Zr and Ti, the mass ratio of Zr to Ti is preferably 1:99-99:1, for example, 8:25 or 1:1.

In the present disclosure, the content range of B is preferably 0-0.9 mas %, for example, 0.5 mas %.

In the present disclosure, the heavy rare earth alloy preferably comprises the following components by mass percentage: Dy: 69-75 mas %, Zr: 6.5-7.5 mas %, B: 0-0.6 mas %, the balance is Fe and/or Co.

In the present disclosure, the heavy rare earth alloy preferably comprises the following components by mass percentage: Dy: 69-75 mas %, Ti: 6.5-7.5 mas %, B: 0-0.6 mas %, the balance is Fe and/or Co.

In a preferred embodiment of the present disclosure, the composition and content of the heavy rare earth alloy can be any one of the following numbers 1-5 (mas %):

| No. | 1 | 2 | 3 | 4 | 5 |
|---|---|---|---|---|---|
| RH | 75 | 69 | 60.2 | 40 | 62.5 |
| Tb | / | / | 50.2 | 30 | 34 |
| Dy | 75 | 69 | / | 5 | 3 |
| Ho | / | / | 10 | / | 2.3 |
| Gd | / | / | / | 5 | 23.2 |
| Ti | / | 7.5 | 4 | 6.25 | 10 |
| Zr | 7.27 | / | 4 | 2 | 10 |
| B | 0.5 | 0.5 | / | 1 | 0.9 |
| Fe and/or Co | balance | balance | balance | balance | balance |

The second purpose of the present disclosure is to provide a use of the above heavy rare earth alloy as a sub-alloy (also known as an “auxiliary alloy”) for preparing a neodymium-iron-boron permanent magnet material by a double alloy method.

The third purpose of the present disclosure is to provide a raw material of neodymium-iron-boron permanent magnet material, comprising a main alloy and a sub-alloy; the sub-alloy is the heavy rare earth alloy;

the main alloy comprises the following components by mass percentage: R: 28.5-33.5 mas %; M: 0-5 mas %; B, 0.85-1.1 mas %, Fe: 60-70 mas %; the sum of each component is 100 mas %, wherein mas % refers to the mass percentage relative to the main alloy;

R is rare earth element and the R comprises Nd; M comprises one or more selected from the group consisting of Co, Cu, Al, Ga, Ti, Zr, W, Nb, V, Cr, Ni, Zn, Ge, Sn, Mo, Pb and Bi;

the mass ratio of main alloy to sub-alloy is (90-100): (0-10), wherein the main alloy is exclusive of 100 mas %, and the sub-alloy is exclusive of 0 mas %, wherein mas % refers to the mass percentage relative to the total mass of the main alloy and the sub-alloy.

In the present disclosure, the total weight of the main alloy changes when element types are increased or reduced in the main alloy. Here, for the dosage of each element, the mass percentage content of existing elements other than Fe does not change, and the sum of each element is achieved to be 100% just by decreasing or increasing the percentage content of Fe.

In the present disclosure, the mass ratio of main alloy to sub-alloy is (95-99): (1-5), for example, 97:3 or 92:8.

In the present disclosure, the content range of R is preferably 29-32.5 mas %, for example, 31.07 mas %, 31.3 mas % or 31.76 mas %, wherein mas % refers to the mass percentage relative to the main alloy.

In the present disclosure, Nd in the R can be added in conventional forms in the art, for example, added in the form of PrNd, or in the form of pure Nd, or in the form of a mixture of pure Pr and Nd, or in combination as PrNd and the mixture of pure Pr and Nd. When Pr is added in the form of PrNd, the weight ratio of Pr to Nd in PrNd is 25:75 or 20:80.

In the present disclosure, the content range of Nd is preferably 17-28.5 mas %, for example, 19.7 mas %, 21 mas % or 22.5 mas %, wherein mas % refers to the mass percentage relative to the main alloy.

In the present disclosure, the type of R preferably comprises one or more selected from the group consisting of Pr, Dy, Tb, Ho and Gd.

Herein, when R comprises Pr, Pr can be added in conventional forms in the art, for example, in the form of PrNd, or in the form of a mixture of pure Pr and Nd, or in a combination of a mixture of PrNd, pure Pr and Nd. When Pr is added in the form of PrNd, the weight ratio of Pr to Nd in PrNd is 25:75 or 20:80.

Herein, when R comprises Pr, the content range of Pr is preferably 0-10 mas %, exclusive of 0, for example, 5.26 mas %, 5.6 mas % or 6 mas %, wherein mas % refers to the mass percentage relative to the main alloy.

Herein, when R comprises Dy, the content range of Dy is preferably 0.5-6 mas %, for example, 5 mas %, 4.27 mas %, 1 mas % or 1.3 mas %, wherein mas % refers to the mass percentage relative to the main alloy.

Herein, when R comprises Gd, the content range of Gd is preferably 0.2-2 mas %, for example, 0.46 mas %, 0.5 mas %, 1 mas % or 1.5 mas %, wherein mas % refers to the mass percentage relative to the main alloy.

Herein, when R comprises Tb, the content range of Tb can be conventional in the art; preferably, the content range of Tb is 0-5 mas %, exclusive of 0, wherein mas % refers to the mass percentage relative to the main alloy.

Herein, when R comprises Ho, the content range of Ho can be conventional in the art, preferably, the content range of Ho is 0-5 mas %, exclusive of 0, wherein mas % refers to the mass percentage relative to the main alloy.

Herein, when R comprises Dy and Gd, the mass ratio of Dy to Gd is preferably 1:99-99:1, for example, 10:1, 1:1 or 13:15.

In the present disclosure, the content range of M is preferably 2.5-4 mas %, for example, 2.19 mas %, 1.97 mas %, 2.85 mas %, 1.65 mas % or 1.94 mas %, wherein mas % refers to the mass percentage relative to the main alloy.

In the present disclosure, the type of M preferably comprises one or more selected from the group consisting of Ga, Al, Cu, Co, Ti, Zr and Nb, for example, the type of M comprises Ga, Al, Cu, Co, Nb and Zr; Ga, Al, Cu, Co, Nb and Ti; Ga, Al, Cu and Co; Ga, Al, Cu, Ti and Zr.

Herein, when M comprises Ga, the content range of Ga is preferably 0-1 mas %, exclusive of 0, for example, 0.26 mas %, 0.3 mas %, 0.1 mas % or 0.5 mas %, wherein mas % refers to the mass percentage relative to the main alloy.

Herein, when M comprises Al, the content range of Al is preferably 0-1 mas %, exclusive of 0, for example, 0.25 mas %, 0.19 mas %, 0.5 mas %, 0.05 mas % or 0.04 mas %, wherein mas % refers to the mass percentage relative to the main alloy.

Herein, when M comprises Cu, the content range of Cu is preferably 0-1 mas %, exclusive of 0, for example, 0.21 mas %, 0.1 mas % or 0.2 mas %, wherein mas % refers to the mass percentage relative to the main alloy.

Herein, when M comprises Co, the content range of Co is preferably 0-2.5 mas %, exclusive of 0, for example, 1.2 mas %, 1.15 mas %, 2 mas % or 1.3 mas %, more preferably 1-2 mas %, wherein mas % refers to the mass percentage relative to the main alloy.

Herein, when M comprises Ti, the content range of Ti is preferably 0-1 mas %, exclusive of 0, for example, 0.1 mas %, wherein mas % refers to the mass percentage relative to the main alloy.

Herein, when M comprises Zr, the content range of Zr is preferably 0-1 mas %, exclusive of 0, for example, 0.25 mas %, 0.1 mas % or 0.095 mas %, wherein mas % refers to the mass percentage relative to the main alloy.

Herein, when M comprises Nb, the content range of Nb is preferably 0-0.5 mas %, exclusive of 0, for example, 0.02 mas % or 0.05 mas %, wherein mas % refers to the mass percentage relative to the main alloy.

In the present disclosure, the content of B is preferably 0.9-1.05 mas %, for example, 0.99 mas %, 1 mas % or 0.95 mas %, wherein mas % refers to the mass percentage relative to the main alloy.

In a preferred embodiment of the present disclosure, the raw material of neodymium-iron-boron permanent magnet material can be any one of the following numbers 1-5 (mas %):

| No. | | 1 | 2 | 3 | 4 | 5 |
|---|---|---|---|---|---|---|
| main alloy | R | 31.76 | 31.07 | 29 | 32 | 31.3 |
| | Nd | / | / | / | / | 28.5 |
| | PrNd | 26.3 | 26.3 | 28 | 30 | / |
| | Dy | 5 | 4.27 | 1 | 1 | 1.3 |
| | Gd | 0.46 | 0.5 | / | 1 | 1.5 |
| | Ga | 0.26 | 0.3 | 0.3 | 0.1 | 0.5 |
| | Al | 0.25 | 0.19 | 0.5 | 0.05 | 0.04 |
| | Cu | 0.21 | 0.21 | / | 0.1 | 0.2 |
| | Co | 1.2 | 1.15 | 2 | 1.3 | / |
| | Ti | / | 0.1 | / | / | 0.1 |
| | Zr | 0.25 | / | / | 0.1 | 0.095 |
| | Nb | 0.02 | 0.02 | 0.05 | / | / |
| | B | 0.99 | 0.99 | 1.1 | 1 | 0.95 |
| | Fe | balance | balance | balance | balance | balance |
| sub-alloy | RH | 75 | 69 | 60.2 | 40 | 62.5 |
| | Tb | / | / | 50.2 | 30 | 34 |
| | Dy | 75 | 69 | / | 5 | 3 |
| | Ho | / | / | 10 | / | 2.3 |
| | Gd | / | / | / | 5 | 23.2 |
| | Ti | / | 7.5 | 4 | 6.25 | 10 |
| | Zr | 7.27 | / | 4 | 2 | 10 |
| | B | 0.5 | 0.5 | / | 1 | 0.9 |
| | Fe and/or Co | balance | balance | balance | balance | balance |
| mass ratio | main alloy:sub- | 97:3 | 97:3 | 90:10 | 92:8 | 95:5 |
| | alloy | | | | | |

The fourth purpose of the present disclosure is to provide a preparation method for a neodymium-iron-boron permanent magnet material, comprising the following steps: the molten liquid of the main alloy and the sub-alloy in the raw material of the neodymium-iron-boron permanent magnet material is subject to casting respectively to obtain a main alloy sheet and a sub-alloy sheet; the main alloy sheet and the sub-alloy sheet are subject to hydrogen decrepitation, and a micro-pulverized mixture thereof is subject to forming and sintering to obtain the neodymium-iron-boron permanent magnet material.

In the present disclosure, preferably, the preparation method comprises the following steps: the molten liquid of the main alloy and the sub-alloy in the raw material of the neodymium-iron-boron permanent magnet material is subjected to casting respectively to obtain a main alloy sheet and a sub-alloy sheet; the mixture of the main alloy sheet and the sub-alloy sheet is subject to hydrogen decrepitation, micro-pulverization, forming and sintering to obtain the neodymium-iron-boron permanent magnet material;

or, the preparation method comprises the following steps: the molten liquid of the main alloy and the sub-alloy in the raw material of the neodymium-iron-boron permanent magnet material is subject to casting respectively to obtain a main alloy sheet and a sub-alloy sheet; the main alloy sheet and the sub-alloy sheet are subject to hydrogen decrepitation respectively, following by mixing the coarse powder of the main alloy sheet and the sub-alloy sheet after hydrogen decrepitation, and then the coarse powder mixed is subject to micro-pulverization, forming and sintering to obtain the neodymium iron boron permanent magnet material;

or, the preparation method comprises the following steps: the molten liquid of the main alloy and the sub-alloy in the raw material of the neodymium-iron-boron permanent magnet material is subject to casting respectively to obtain a main alloy sheet and a sub-alloy sheet; the main alloy sheet and the sub-alloy sheet are subject to hydrogen decrepitation and micro-pulverization respectively, following by mixing the fine powder of the main alloy sheet and the sub-alloy sheet after micro-pulverization, and then the fine powder mixed is subject to forming and sintering to obtain the neodymium iron boron permanent magnet material.

In the present disclosure, the casting, the hydrogen decrepitation, the micro-pulverization, the forming and the sintering are all conventional operation methods with conventional conditions in the art.

In the present disclosure, the molten liquid can be prepared by conventional methods in the art, for example, by melting in a melting furnace. The vacuum degree of the melting furnace can be less than 5×10⁻² Pa. The melting temperature can be 1300-1600° C.

In the present disclosure, the casting process can be a conventional casting process in the art, for example, thin strip continuous casting method, ingot casting method, centrifugal casting method or rapid quenching method.

In the present disclosure, the time of hydrogen decrepitation can be conventional in the art, which can be 1-6 h. The condition of the hydrogen decrepitation can be conventional in the art. The dehydrogenation temperature of the hydrogen decrepitation can be 400° C.-650° C. The time of hydrogen decrepitation can be 1-6 h.

In the present disclosure, the micro-pulverization process can be a conventional pulverization process in the art, for example, jet mill pulverization, which can be carried out preferably under an atmosphere with an oxidizing gas content less than 50 ppm. The particle size of the micro-pulverized powder can be 2-7 μm.

In the present disclosure, the condition of the forming can be conventional in the art, for example, being pressed in a press with a magnetic field strength of 0.5 T-3.0 T to form a green body. The pressing time can be conventional in the art, which can be 3-30 s. In the present disclosure, the condition of the sintering treatment can be conventional in the art. The sintering temperature can be 1000° C.-1100° C. The sintering time can be 4-20 h.

The fifth purpose of the present disclosure is to provide a neodymium-iron-boron permanent magnet material prepared by the preparation method for the neodymium-iron-boron permanent magnet material.

In the present disclosure, the neodymium-iron-boron permanent magnet material comprises Nd₂Fe₁₄B main phase and a grain boundary phase distributed between the main phases, and the grain boundary phase comprises Zr—B phase and/or Ti—B phase; wherein the proportional relationship of the Zr—B phase and/or the Ti—B phase is: “(Xₐ—B_{b})ₓ-T_{y}-Mₚ-R_{z}”, wherein X, M and R are set forth, T is Fe and/or Co; wherein, a<b<2a, 10 at %<x<40 at %, 10 at %<y<40 at %, 20 at %<z<80 at %, 5 at %<p<20 at %.

Herein, preferably, the grain boundary phase further comprises an oxide of RH, and the type of RH is set forth.

Herein, preferably, the content of Zr and/or Ti element in the grain boundary phase is higher than the content of Zr and/or Ti element in the Nd₂Fe₁₄B main phase.

Herein, the range of x is preferably 20-35 at %, wherein at % refers to the atomic percentage of each element.

Herein, the range of y is preferably 20-35 at %, wherein at % refers to the atomic percentage of each element.

Herein, the range of z is preferably 25-45 at %, wherein at % refers to the atomic percentage of each element.

Herein, the range of p is preferably 10-25 at %, wherein at % refers to the atomic percentage of each element.

Based on the common sense in the field, the preferred conditions of the preparation methods can be combined arbitrarily to obtain preferred examples of the present disclosure.

In the present disclosure, “(BH) max” refers to the maximum magnetic energy product. “Bᵣ” refers to remanence: the retaining magnetism after removal of external magnetic field following saturation magnetization of permanent magnet materials is called remanence. “Hc” refers to coercivity, magnetic polarization coercivity Hcj (intrinsic coercivity), and magnetic induction coercivity H_{cb}. “Hk/Hcj” refers to squareness.

The reagents and raw materials used in the present disclosure are all commercially available.

The positive progress effects of the present invention are as follows: when the heavy rare earth alloy of the present invention is used as a sub-alloy to prepare the neodymium-iron-boron permanent magnet material, a high utilization rate of heavy rare earth is achieved, so that the coercivity can also be greatly improved while the neodymium-iron-boron permanent magnet material maintains high remanence.

### BRIEF DESCRIPTION OF THE DRAWINGS

FIG. 1 shows the element distribution image of Pr, O, Co, Zr, B, CP, Nd, Al, Cu, Nb, Dy, Ga and Gd formed by FE-EPMA surface scan of the magnet prepared in Example 1.

FIG. 2 shows the backscattering image of the sintered magnet FE-EPMA prepared in Example 1.

### DETAILED DESCRIPTION OF THE PREFERRED EMBODIMENT

The present disclosure is further described below by way of examples; however, the present disclosure is not limited to the scope of the examples described hereinafter. For the experimental methods in which no specific conditions are specified in the following examples, selections are made according to conventional methods and conditions or according to the product instructions.

### Examples 1-5 and Comparative Examples 1-5

(1) Casting process: according to the formulations of Examples 1-5 and Comparative Examples 1-5 shown in Table 1 and the corresponding ratio of alloy A and alloy B, corresponding composition was taken and put into the vacuum melting furnace for vacuum melting in a vacuum of 5×10⁻² Pa at a temperature of 1450° C. respectively; then, the molten liquids obtained by melting were respectively cast by the thin strip continuous casting method to obtain main alloy sheets and sub-alloy sheets.

(2) Hydrogen decrepitation process: at room temperature, the mixture of main alloy sheets and sub alloy sheets in step (1) were subject to hydrogen decrepitation treatment at 550° C. for 3 hours to obtain coarsely pulverized powder.

(3) Micro-pulverization process: the coarsely pulverized powder in step (2) is subject to micro-pulverization in an atmosphere with an oxidizing gas content of 50 ppm or less in a jet mill to obtain a micro-pulverized powder with an average particle size of D50 4 μm.

(4) Forming process: the powder was pressed in a press with a magnetic field strength of 2.0 T for 15 s to form a green body, and then held for 15 s under the condition of a pressure of 260 MPa to obtain a molded body.

(5) Sintering process: the molded body was sintered at 1070° C. for 7 hours, with the sintering atmosphere vacuum or argon atmosphere to obtain neodymium-iron-boron permanent magnet material.

TABLE 1
The components and contents of raw material composition for neodymium-iron-boron permanent magnet material (mas %)

| | | | | | | | Compar- | Compar- | Compar- | Compar- | Compar- |
|---|---|---|---|---|---|---|---|---|---|---|---|
| | | | | | | | ative | ative | ative | ative | ative |
| No. | | Example 1 | Example 2 | Example 3 | Example 4 | Example 5 | Example 1 | Example 2 | Example 3 | Example 4 | Example 5 |
| main alloy | R | 31.76 | 31.07 | 29 | 32 | 31.3 | 32.28 | 29 | 31.07 | 31.07 | 31.07 |
| | Nd | / | / | / | / | 28.5 | / | / | / | / | / |
| | PrNd | 26.3 | 26.3 | 28 | 30 | / | 25.51 | 28 | 26.3 | 26.3 | 26.3 |
| | Dy | 5 | 4.27 | 1 | 1 | 1.3 | 7.10 | 1 | 4.27 | 4.27 | 4.27 |
| | Gd | 0.46 | 0.5 | / | 1 | 1.5 | 0.45 | / | 0.5 | 0.5 | 0.5 |
| | Ga | 0.26 | 0.3 | 0.3 | 0.1 | 0.5 | 0.25 | 0.3 | 0.3 | 0.3 | 0.3 |
| | Al | 0.25 | 0.19 | 0.5 | 0.05 | 0.04 | 0.24 | 0.5 | 0.19 | 0.19 | 0.19 |
| | Cu | 0.21 | 0.21 | / | 0.1 | 0.2 | 0.20 | / | 0.21 | 0.21 | 0.21 |
| | Co | 1.2 | 1.15 | 2 | 1.3 | / | 1.16 | 2 | 1.15 | 1.15 | 1.15 |
| | Ti | / | 0.1 | / | / | 0.1 | / | / | 0.1 | 0.1 | 0.1 |
| | Zr | 0.25 | / | / | 0.1 | 0.095 | 0.46 | / | / | / | / |
| | Nb | 0.02 | 0.02 | 0.05 | / | / | 0.02 | 0.05 | 0.02 | 0.02 | 0.02 |
| | B | 0.99 | 0.99 | 1.1 | 1 | 0.95 | 0.98 | 1.1 | 0.99 | 0.99 | 0.99 |
| | Fe | balance | balance | balance | balance | balance | balance | balance | balance | balance | balance |
| sub-alloy | RH | 75 | 69 | 60.2 | 40 | 62.5 | / | 60.2 | 20 | 25 | 69 |
| | Tb | / | / | 50.2 | 30 | 34 | / | 50.2 | / | / | / |
| | Dy | 75 | 69 | / | 5 | 3 | / | / | 20 | 25 | 69 |
| | Ho | / | / | 10 | / | 2.3 | / | 10 | / | / | / |
| | Gd | / | / | / | 5 | 23.2 | / | / | / | / | / |
| | Ti | / | 7.5 | 4 | 6.25 | 10 | / | 4 | 7.5 | 22.5 | 22 |
| | Zr | 7.27 | / | 4 | 2 | 10 | / | 4 | / | / | |
| | B | 0.5 | 0.5 | / | 1 | 0.9 | / | / | 0.5 | 0.5 | 0.5 |
| | Fe and/or Co | balance | balance | balance | balance | balance | balance | balance | balance | balance | balance |
| mass ratio | main alloy:sub- | 97:3 | 97:3 | 90:10 | 92:8 | 95:5 | 100:0 | 87:13 | 97:3 | 97:3 | 97:3 |
| | alloy | | | | | | | | | | |

“/” means that the element is exclusive.

The components and content of the neodymium-iron-boron permanent magnet material in Table 2 below are the nominal composition calculated from the data in Table 1, ignoring the loss.

TABLE 2
The components and content of neodymium-iron-boron permanent magnet material (mas %)

| | | | | | | Compar- | Compar- | Compar- | Compar- | Compar- |
|---|---|---|---|---|---|---|---|---|---|---|
| | | | | | | ative | ative | ative | ative | ative |
| | Example 1 | Example 2 | Example 3 | Example 4 | Example 5 | Example 1 | Example 2 | Example 3 | Example 4 | Example 5 |
| R | 33.06 | 32.21 | 32.12 | 32.64 | 32.86 | 32.28 | 33.06 | 30.74 | 30.89 | 32.21 |
| Nd | / | / | / | / | 27.08 | / | / | / | / | / |
| PrNd | 25.51 | 25.51 | 25.20 | 27.60 | / | 25.51 | 24.36 | 25.51 | 25.51 | 25.51 |
| Dy | 7.10 | 6.21 | 0.90 | 1.32 | 1.39 | 7.10 | 0.87 | 4.74 | 4.89 | 6.21 |
| Tb | / | / | 5.02 | 2.40 | 1.70 | / | 6.53 | / | / | / |
| Ho | / | / | 1.00 | / | 0.12 | / | 1.3 | / | / | / |
| Gd | 0.45 | 0.49 | / | 1.32 | 2.59 | 0.45 | / | 0.49 | 0.49 | 0.49 |
| Ga | 0.25 | 0.29 | 0.27 | 0.09 | 0.48 | 0.25 | 0.26 | 0.29 | 0.29 | 0.29 |
| Al | 0.24 | 0.18 | 0.45 | 0.05 | 0.04 | 0.24 | 0.44 | 0.18 | 0.18 | 0.18 |
| Cu | 0.20 | 0.20 | / | 0.09 | 0.19 | 0.20 | / | 0.20 | 0.20 | 0.20 |
| Co | 1.16 | 1.12 | 1.80 | 1.20 | / | 1.16 | 1.74 | 1.12 | 1.12 | 1.12 |
| Ti | / | 0.32 | 0.4 | 0.5 | 0.6 | / | 0.52 | 0.32 | 0.77 | 0.76 |
| Zr | 0.46 | / | 0.4 | 0.25 | 0.59 | 0.46 | 0.52 | / | / | / |
| Nb | 0.02 | 0.02 | 0.05 | / | / | 0.02 | 0.04 | 0.02 | 0.02 | 0.02 |
| O | 0.05 | 0.05 | 0.05 | 0.05 | 0.05 | 0.05 | 0.05 | 0.05 | 0.05 | 0.05 |
| B | 0.98 | 0.98 | 0.99 | 1.00 | 0.95 | 0.98 | 0.957 | 0.98 | 0.98 | 0.98 |
| Fe and/ | balance | balance | balance | balance | balance | balance | balance | balance | balance | balance |
| or Co | | | | | | | | | | |

“/” means that the element is exclusive.

### Effective Example

The neodymium-iron-boron permanent magnet materials prepared in Examples 1-5 and Comparative Examples 1-5 were taken to observe the crystalline phase structure of the magnets by FE-EPMA respectively.

(1) Magnetic properties evaluation: the neodymium-iron-boron permanent magnet materials were tested for magnetic properties by using the PFM14.CN ultra-high coercivity permanent magnet measurement system from The National Institute of Metrology, China.

TABLE 3
Properties of Neodymium-Iron-Boron Permanent Magnet Materials

| | Br | Hcj | Hcb | Bhmax | |
|---|---|---|---|---|---|
| No. | (kGs) | (kOe) | (kOe) | (MGOe) | Hk/Hcj |
| Example 1 | 11.82 | 34.85 | 11.59 | 33.09 | 95.73 |
| Example 2 | 12.00 | 32.77 | 11.73 | 35.03 | 95.95 |
| Example 3 | 11.80 | 40.59 | 11.57 | 33.07 | 95.68 |
| Example 4 | 12.68 | 28.97 | 12.33 | 38.95 | 95.66 |
| Example 5 | 12.11 | 28.74 | 11.89 | 35.75 | 95.78 |
| Comparative Example 1 | 11.79 | 32.92 | 11.51 | 32.81 | 94.80 |
| Comparative Example 2 | 11.09 | 44.53 | 10.65 | 29.58 | 93.23 |
| Comparative Example 3 | 12.59 | 27.53 | 12.31 | 38.62 | 94.85 |
| Comparative Example 4 | 12.45 | 27.11 | 12.23 | 37.92 | 94.50 |
| Comparative Example 5 | 11.89 | 31.58 | 11.62 | 33.85 | 94.53 |

“(BH)ₘₐₓ” refers to the maximum magnetic energy product. “Br” refers to remanence (the retaining magnetism after removal of external magnetic field following saturation magnetization of permanent magnet materials is called remanence). “Hc” refers to coercivity: magnetic polarization coercivity Hcj (intrinsic coercivity) and magnetic induction coercivity Hcb. “Hk/Hcj” refers to squareness.

(2) FE-EPMA Test:

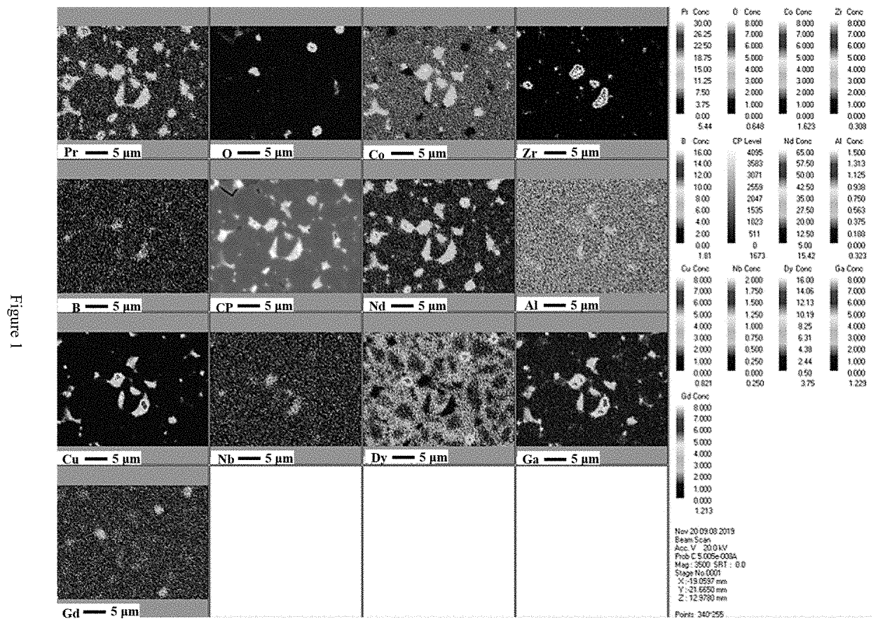

FIG. 1 shows the element distribution image of Pr, O, Co, Zr, B, CP, Nd, Al, Cu, Nb, Dy, Ga and Gd formed by FE-EPMA surface scan of the magnet prepared in Example 1.

TABLE 4

| No. | element | Nd | Pr | Al | O | Ga | Cu | Co | Dy | Gd | Nb | Zr | B | Fe | sum |
|---|---|---|---|---|---|---|---|---|---|---|---|---|---|---|---|
| point 1 | at % | 34.6 | 6.4 | 0.0225 | 46.8 | 0.033 | 0 | 0 | 7.8 | 0 | 0.0849 | 0.0283 | 0.1208 | 4.1 | 100 |
| | mas % | 61.3 | 11.1 | 0.007 | 9.2 | 0.028 | 0 | 0 | 15.5 | 0 | 0.097 | 0.032 | 0.016 | 2.8 | 100 |
| point 2 | at % | 26.1 | 7.1 | 0.8921 | 5.3 | 3.28 | 5.87 | 4.96 | 0.72 | 1.76 | 0.3151 | 9.7 | 16.22 | 17.8 | 100 |
| | mas % | 45.6 | 12.2 | 0.292 | 1 | 2.77 | 4.53 | 3.54 | 1.4 | 3.35 | 0.355 | 10.73 | 2.13 | 12.1 | 100 |
| point 3 | at % | 44 | 13 | 0.151 | 3.1 | 0.31 | 0.4 | 0.81 | 1.1 | 0 | 0.0113 | 0.085 | 0.0749 | 37 | 100 |
| | mas % | 60 | 17.4 | 0.038 | 0.47 | 0.21 | 0.24 | 0.45 | 1.6 | 0 | 0.01 | 0.073 | 0.007 | 19.5 | 100 |
| point 4 | at % | 7.9 | 1.5 | 0.431 | 2.1 | 0.11 | 0 | 1.16 | 1.3 | 0.53 | 0.0096 | 0.0435 | 3.55 | 81.4 | 100 |
| | mas % | 18 | 3.3 | 0.183 | 0.52 | 0.12 | 0 | 1.08 | 3.3 | 1.31 | 0.014 | 0.062 | 0.603 | 71.5 | 100 |

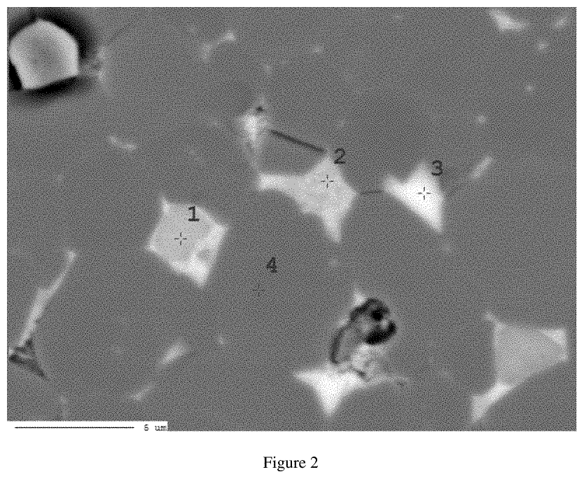

As shown in Table 4 and FIG. 2, point 3 is a conventional grain boundary phase, and point 4 is the main phase; Zr—B phase (point 2) was generated in the grain boundary, resulting in that RH can only combine with O instead of combining with B to form the oxide phase of RH (point 1), therefore, the content of heavy rare earth in point 1 is higher, while the content of B in point 2 is higher; also, since the melting point of RH oxide is high, the excessive diffusion of RH from the grain boundary to the main phase and the combination with B in the main phase are inhibited thereby, which explains the reason for the performance improvement of the neodymium-iron-boron magnet material in the present disclosure from the mechanism.

1. A heavy rare earth alloy comprising the following components by mass percentage: RH: 30-100 mas %, exclusive of 100 mas %; X, 0-20 mas %, exclusive of 0; B: 0-1.1 mas %; and Fe and/or Co: 15-69 mas %, wherein the sum of each component is 100 mas %, wherein mas % refers to the mass percentage relative to the heavy rare earth alloy;
RH comprises one or more heavy rare earth elements selected from the group consisting of Gd, Tb, Dy, Ho, Er, Tm, Yb, Lu and Sc;
and X is Ti and/or Zr.

2. The heavy rare earth alloy according to claim 1, wherein, the content range of RH is 30-90 mas %, wherein mas % refers to the mass percentage relative to the heavy rare earth alloy;
or, the type of RH comprises one or more heavy rare earth elements selected from the group consisting of Tb, Dy, Ho and Gd;
or, the content range of X is 3-15 mas %, wherein mas % refers to the mass percentage relative to the heavy rare earth alloy;
or, the content range of B is 0-0.9 mas %.

3. The heavy rare earth alloy according to claim 2, wherein, when RH comprises Tb, the content range of Tb is 30-75 mas %, wherein mas % refers to the mass percentage relative to the heavy rare earth alloy;
when RH comprises Dy, the content range of Dy is 3-75 mas %, wherein mas % refers to the mass percentage relative to the heavy rare earth alloy;
when RH comprises Ho, the content range of Ho is 2-50 mas %, wherein mas % refers to the mass percentage relative to the heavy rare earth alloy;
when RH comprises Gd, the content range of Gd is 2-50 mas %, wherein mas % refers to the mass percentage relative to the heavy rare earth alloy;
when RH comprises Tb and Dy, the content range of “Tb and Dy” is 30-90 mas %, wherein mas % refers to the mass percentage relative to the heavy rare earth alloy;
when RH comprises Tb and Ho, the content range of “Tb and Ho” is 30-90 mas %, wherein mas % refers to the mass percentage relative to the heavy rare earth alloy;
when RH comprises Tb and Gd, the content range of “Tb and Gd” is 30-90 mas %, wherein mas % refers to the mass percentage relative to the heavy rare earth alloy;
when RH comprises Tb, Dy and Gd, the content range of “Tb, Dy and Gd” is 30-90 mas %, wherein mas % refers to the mass percentage relative to the heavy rare earth alloy;
when RH comprises Tb, Dy, Ho and Gd, the content range of “Tb, Dy, Ho and Gd” is 30-90 mas %, wherein mas % refers to the mass percentage relative to the heavy rare earth alloy.

4. The heavy rare earth alloy according to claim 1, wherein, when X comprises Ti, the content range of Ti is 3-15%, wherein mas % refers to the mass percentage relative to the heavy rare earth alloy;
when X comprises Zr, the content range of Zr is 3-10%, wherein mas % refers to the mass percentage relative to the heavy rare earth alloy;
when X comprises a mixture of Zr and Ti, the mass ratio of Zr to Ti is 1:99-99:1.

5. The heavy rare earth alloy according to claim 1, comprising the following components by mass percentage: Dy: 69-75 mas %, Zr: 6.5-7.5 mas %, B: 0-0.6 mas %, the balance is Fe and/or Co;
or, the heavy rare earth alloy comprises the following components by mass percentage: Dy: 69-75 mas %, Ti: 6.5-7.5 mas %, B: 0-0.6 mas %, the balance is Fe and/or Co.

6. An application of the heavy rare earth alloy according to claim 1 as a sub-alloy for preparing a neodymium-iron-boron permanent magnet material by a double alloy method.

7. A raw material of neodymium-iron-boron permanent magnet material, comprising a main alloy and a sub-alloy; the sub-alloy is the heavy rare earth alloy according to claim 1;
the main alloy comprises the following components by mass percentage: R: 28.5-33.5 mas %; M: 0-5 mas %; B, 0.85-1.1 mas %, Fe: 60-70 mas %; the sum of each component is 100 mas %, wherein mas % refers to the mass percentage relative to the main alloy;
R is rare earth element and the R comprises Nd;
M comprises one or more selected from the group consisting of Co, Cu, Al, Ga, Ti, Zr, W, Nb, V, Cr, Ni, Zn, Ge, Sn, Mo, Pb and Bi;
the mass ratio of main alloy to sub-alloy is (90-100):(0-10), wherein the main alloy is exclusive of 100 mas %, and the sub-alloy is exclusive of 0 mas %, wherein mas % refers to the mass percentage relative to the total mass of the main alloy and the sub-alloy.

8. The raw material of neodymium-iron-boron permanent magnet material according to claim 7, wherein, the mass ratio of main alloy to sub-alloy is (95-99):(1-5);
or, the content range of R is 29-32.5 mas %, wherein mas % refers to the mass percentage relative to the main alloy;
or, the content range of Nd is 17-28.5 mas %, wherein mas % refers to the mass percentage relative to the main alloy;
or, the type of R comprises one or more selected from the group consisting of Pr, Dy, Tb, Ho and Gd;
or, the content range of M is 2.5-4 mas %, wherein mas % refers to the mass percentage relative to the main alloy;
or, the type of M comprises one or more selected from the group consisting of Ga, Al, Cu, Co, Ti, Zr and Nb;
or, the content of B is 0.9-1.05 mas %, wherein mas % refers to the mass percentage relative to the main alloy.

9. A preparation method for a neodymium-iron-boron permanent magnet material, comprising the following steps: the molten liquid of the main alloy and the sub-alloy in the raw material of the neodymium-iron-boron permanent magnet material according to claim 7 is subject to casting respectively to obtain a main alloy sheet and a sub-alloy sheet; the main alloy sheet and the sub-alloy sheet are subject to hydrogen decrepitation, and a micro-pulverized mixture thereof is subject to forming and sintering to obtain the neodymium-iron-boron permanent magnet material.

10. A neodymium-iron-boron permanent magnet material prepared by the preparation method for the neodymium-iron-boron permanent magnet material according to claim 9.

11. The heavy rare earth alloy according to claim 5, wherein the heavy rare earth alloy comprises the following components by mass percentage: Dy: 75 mas %, Zr: 7.27 mas %, B:
0.5 mas %, the balance is Fe and/or Co;
or, the heavy rare earth alloy comprises the following components by mass percentage: Dy: 69 mas %, Ti: 7.5 mas %, B: 0.5 mas %, the balance is Fe and/or Co.

12. The raw material of neodymium-iron-boron permanent magnet material according to claim 8, wherein:
when R comprises Pr, the content range of Pr is 0-10 mas %, exclusive of 0, wherein mas % refers to the mass percentage relative to the main alloy;
when R comprises Dy, the content range of Dy is 0.5-6 mas %, wherein mas % refers to the mass percentage relative to the main alloy;
when R comprises Gd, the content range of Gd is 0.2-2 mas %, wherein mas % refers to the mass percentage relative to the main alloy;
when R comprises Tb, the content range of Tb is 0-5 mas %, exclusive of 0, wherein mas % refers to the mass percentage relative to the main alloy;
when R comprises Ho, the content range of Ho is 0-5 mas %, exclusive of 0, wherein mas % refers to the mass percentage relative to the main alloy;
when R comprises Dy and Gd, the mass ratio of Dy to Gd is 1:99-99:1.

13. The raw material of neodymium-iron-boron permanent magnet material according to claim 8, wherein:
when M comprises Ga, the content range of Ga is 0-1 mas %, exclusive of 0, wherein mas % refers to the mass percentage relative to the main alloy;
when M comprises Al, the content range of Al is 0-1 mas %, exclusive of 0, wherein mas % refers to the mass percentage relative to the main alloy;
when M comprises Cu, the content range of Cu is 0-1 mas %, exclusive of 0, wherein mas % refers to the mass percentage relative to the main alloy;
when M comprises Co, the content range of Co is 0-2.5 mas %, exclusive of 0, wherein mas % refers to the mass percentage relative to the main alloy;
when M comprises Ti, the content range of Ti is 0-1 mas %, exclusive of 0, wherein mas % refers to the mass percentage relative to the main alloy;
when M comprises Zr, the content range of Zr is 0-1 mas %, exclusive of 0, wherein mas % refers to the mass percentage relative to the main alloy;
when M comprises Nb, the content range of Nb is 0-0.5 mas %, exclusive of 0, wherein mas % refers to the mass percentage relative to the main alloy.

14. The raw material of neodymium-iron-boron permanent magnet material according to claim 8, wherein the raw material of neodymium-iron-boron permanent magnet material comprises the following components by mass percentage: the mass ratio of main alloy to sub-alloy is 97:3; in the main alloy, PrNd: 26.3 mas %, Dy: 5 mas %, Gd: 0.46 mas %, Ga: 0.26 mas %, Al: 0.25 mas %, Cu: 0.21 mas %, Co: 1.2 mas %, Zr: 0.25 mas %, Nb: 0.02 mas % and B: 0.99 mas %, the balance is Fe, wherein mas % refers to the mass percentage relative to the main alloy; in the sub-alloy: Dy: 75 mas %, Zr: 7.27 mas %, B: 0.5 mas %, the balance is Fe and/or Co.

15. The raw material of neodymium-iron-boron permanent magnet material according to claim 8, wherein the raw material of neodymium-iron-boron permanent magnet material comprises the following components by mass percentage: the mass ratio of main alloy to sub-alloy is 97:3; in the main alloy, PrNd: 26.3 mas %, Dy: 4.27 mas %, Gd: 0.5 mas %, Ga: 0.3 mas %, Al: 0.19 mas %, Cu: 0.21 mas %, Co: 1.15 mas %, Ti: 0.1 mas %, Nb: 0.02 mas % and B: 0.99 mas %, the balance is Fe, wherein mas % refers to the mass percentage relative to the main alloy; in the sub-alloy: Dy: 69 mas %, Ti: 7.5 mas %, B: 0.5 mas %, the balance is Fe and/or Co.

16. The preparation method according to claim 9, wherein the preparation method comprises the following steps: the molten liquid of the main alloy and the sub-alloy in the raw material of the neodymium-iron-boron permanent magnet material is subjected to casting respectively to obtain a main alloy sheet and a sub-alloy sheet; the mixture of the main alloy sheet and the sub-alloy sheet is subject to hydrogen decrepitation, micro-pulverization, forming and sintering to obtain the neodymium-iron-boron permanent magnet material;
or, the micro-pulverization process is carried out in an atmosphere with oxidizing gas having a content of 50 ppm or less.

17. The preparation method according to claim 9, wherein the preparation method comprises the following steps: the molten liquid of the main alloy and the sub-alloy in the raw material of the neodymium-iron-boron permanent magnet material is subject to casting respectively to obtain a main alloy sheet and a sub-alloy sheet; the main alloy sheet and the sub-alloy sheet are subject to hydrogen decrepitation respectively, following by mixing the coarse powder of the main alloy sheet and the sub-alloy sheet after hydrogen decrepitation, and then the coarse powder mixed is subject to micro-pulverization, forming and sintering to obtain the neodymium iron boron permanent magnet material.

18. The preparation method according to claim 9, wherein the preparation method comprises the following steps: the molten liquid of the main alloy and the sub-alloy in the raw material of the neodymium-iron-boron permanent magnet material is subject to casting respectively to obtain a main alloy sheet and a sub-alloy sheet; the main alloy sheet and the sub-alloy sheet are subject to hydrogen decrepitation and micro-pulverization respectively, following by mixing the fine powder of the main alloy sheet and the sub-alloy sheet after micro-pulverization, and then the fine powder mixed is subject to forming and sintering to obtain the neodymium iron boron permanent magnet material.

19. The neodymium-iron-boron permanent magnet material according to claim 10, wherein the neodymium-iron-boron permanent magnet material comprises Nd₂Fe₁₄B main phase and a grain boundary phase distributed between the main phases, wherein the grain boundary phase comprises Zr—B phase and/or Ti—B phase; the proportional relationship of the Zr—B phase and/or the Ti—B phase is: “(Xₐ—B_{b})ₓ-T_{y}-Mₚ-R_{z}”, wherein X, M and R are set forth in claim 1 independently, T is Fe and/or Co; wherein, a<b<2a, 10 at %<x<40 at %, 10 at %<y<40 at %, 20 at %<z<80 at %, 5 at %<p<20 at %;
or, the grain boundary phase further comprises an oxide of RH, and the type of RH comprises one or more heavy rare earth elements selected from the group consisting of Gd, Tb, Dy, Ho, Er, Tm, Yb, Lu and Sc;
or, the content of Zr and/or Ti element in the grain boundary phase is higher than the content of Zr and/or Ti element in the Nd₂Fe₁₄B main phase.

20. The neodymium-iron-boron permanent magnet material according to claim 19, wherein the range of x is 20-35 at %, wherein at % refers to the atomic percentage of each element;
or, the range of y is 20-35 at %, wherein at % refers to the atomic percentage of each element;
or, the range of z is 25-45 at %, wherein at % refers to the atomic percentage of each element;
or, the range of p is 10-25 at %, wherein at % refers to the atomic percentage of each element.
